(19) United States
(12) Patent Application Publication
(10) Pub. No.: US 2003/0017819 A1
(43) Pub. Date: Jan. 23, 2003

(54) Regional business model for subscription computing

(75) Inventors: David Frederick Bantz, Chappaqua, NY (US); Thomas E. Chefalas, Somers, NY (US); Alexei A. Karve, Peekskill, NY (US); Steven J. Mastrianni, Unionville, CT (US); Ajay Mohindra, Yorktown Heights, NY (US); Dennis Gerard Shea, Ridgefield, CT (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/910,979

(22) Filed: Jul. 20, 2001

(51) Int. Cl. H04M 11/00

(52) U.S. Cl. 455/406; 455/407; 455/408

(57) ABSTRACT

A method, apparatus, and computer implemented instructions for managing services in a data processing system. A request is received for a service from a client. A location of the client is identified in response to receiving the request. Based on the location of the client, a determination is made as to whether the service is to be provided. If the service is provided, the client is billed for the service based on the location of the client.

### BACKGROUND OF THE INVENTION

1. Technical Field

The present invention relates generally to an improved data processing system, and in particular to a method and apparatus for processing data. Still more particularly, the present invention provides a method, apparatus, and computer implemented instructions for providing services to clients on a subscription basis.

2. Description of Related Art

Subscription computing or information technology (IT) outsourcing is a business in which the provider provides a basic IT infrastructure (hardware, networking, system software, personal productivity software) together with services (installation, moves and changes, backup, anti-virus, software installation) and support, for a fee. This business model is advantageous to the customer because it assures access to current technology, eases cash flow, increases service levels, and limits the customer's need to invest in IT skills. The business model is advantageous to the provider because it permits the constituent components and services to be optimized for delivery together. For example, the computer equipment provided may be optimized to make support services less expensive to provide.

Current providers of subscription computing provide these IT services on a regional basis. Some of the services, especially those requiring physical interaction with the customer's equipment, are provided from regional offices. Service guarantees of response time require that service personnel be located physically close to the customer's premises. Although some providers support portable computers, their services typically do not extend to mobile users operating outside their region of support. Their model of geographic support for mobile users is either to provide service or to limit service depending on the location of the user.

This model is neither advantageous to the user nor to the provider. The user has limited service coverage or perhaps no service coverage, when operating outside the region served by the provider. The provider may not be able to charge the user for services if that user does not have access to services, and the determination of whether or not to charge the user cannot be made easily because the user may move in and out of regions in which certain services are unavailable.

Therefore, it would be advantageous to have an improved method, apparatus, and computer implemented instructions for providing services on a regional and subscription basis.

### SUMMARY OF THE INVENTION

The present invention provides for a method, apparatus, and computer implemented instructions for managing services in a data processing system. A request is received for a service from a client. A location of the client is identified in response to receiving the request. Based on the location of the client, a determination is made as to whether the service is to be provided. If the service is provided, the client is billed for the service based on the location of the client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a network data processing system in accordance with a preferred embodiment of the present invention;

FIG. 2 is a block diagram of a data processing system that may be implemented as a server in accordance with a preferred embodiment of the present invention;

FIG. 3 is a diagram illustrating processing of billing events in accordance with a preferred embodiment of the present invention;

FIGS. 4A-4B are diagrams of database entries in accordance with a preferred embodiment of the present invention;

FIG. 5 is a flowchart of a process used for processing a request for a service in accordance with a preferred embodiment of the present invention;

FIG. 6 is a flowchart of a process used for generating a billing entry for a service in accordance with a preferred embodiment of the present invention;

FIG. 7 is a flowchart of a process used for generating a charge in accordance with a preferred embodiment of the present invention; and

FIG. 8 is a flowchart of a process used for determining whether to provide a service in accordance with a preferred embodiment of the present invention.

### DETAILED DESCRIPTION OF THE PREFERRED EMBODIMENT

The present invention recognizes that the constituent services of subscription computing differ in the sensitivity of their provision cost to distance between the service provision site and the user's location. Some services are substantially insensitive to this distance. For example, a user's access to a personalized portal that provides self-help and account administration services is not strongly sensitive to distance because Internet access charges are typically insensitive to the distance between the browser and the server, and the Hypertext Transfer Protocol (HTTP) is substantially insensitive to that component of message latency that is distance-sensitive. For many actions, this service is more sensitive to the available bandwidth than it is to message latency. However, some services are more sensitive to the distance between the service provision site and the user's location. For example, a remote console takeover, in which a service provider can remotely manipulate the graphical user interface (GUI) seen by the user, is sensitive to latency and thus to distance. Services that exchange large numbers of short messages are latency-sensitive. Perhaps the most distance-sensitive service is on-site support, which requires technicians to travel from the service provision site to the user's location.

In the depicted examples, differential sensitivity of subscription computing services to a location is used to identify charges for services provided to customers. One factor taken into account is latency of data transfer. With data transmission, new packets cannot be sent before prior packets arrive at their destination and have been acknowledged, within certain limits.

Accordingly, the present invention disclosed herein concerns a differential charging and service quality provision model for subscription computing, charges and service quality being explicitly a function of the distance between the current user's location and the service provision site. These charges may be a continuous function of distance or may be quantized into regions, progressively further from the service provider. As a user roams further away from the service provision site services are still provided, but with longer latency and higher cost. Those services that are not latency-sensitive do not contribute to an increased cost of service provision, while those that are, do. This increased cost of service provision is reflected in the charging model.

It may be the case that certain services, such as on-site support, are not practical for a service provider to provide that service, beyond a certain distance. This may be because, for example, work rules limit the distance that a technician can travel. The service provider then has several options with respect to this service if the user is in a distant region. The service can simply be made unavailable. The provider may require that the user travel to an intermediate site, thus sharing the time and cost of travel with the user. Additionally, the provider may have made partnership agreements with a neighboring service provider in a manner similar to that of cellular telephone service providers, except that only those services that are distance-sensitive need be provided by the local provider and those that are not continue to be provided by the home provider.

With reference now to the Figures and in particular to FIG. 1, a diagram of a network data processing system is depicted in accordance with a preferred embodiment of the present invention. Network data processing system 100 is an example of a system in which the present invention may be provided. In this example, customer premises 102 includes local area network (LAN) 104 to which personal computers (PCs) 106, 108, and 110 are connected. Interaction with Internet 112 is provided through gateway 114. Notebook 116 is a mobile computing system connected to Internet 112. In this example, notebook 116, PC 106, PC 108, and PC 100 are data processing systems supported through a subscription computing service provided through service provider premises 118.

In this example, service provider premises 118 includes servers 120, 122, and 124, which provide selected services to these data processing systems. Some of these services may include, for example, a user help portal, remote automatic diagnosis, and help desk services. A user help portal may be provided to help users to obtain information on various applications. Remote automatic diagnosis services may be provided for initial trouble-shooting. Help desk services may involve human operators at service provider premises 118 providing live help through chat rooms or other messaging systems. Other services that may be provided include, for example, backup services, anti-virus services, and remote software installation services. Additionally, based on requests received by these servers, on-site services may be initiated and confirmed.

Servers 120, 122, and 124 are connected to backend services, such as those provided by account management server 126 and billing server 128 through local area network (LAN) 130. Account management server 126 manages accounts for various customers using account database 132. Billing services for billing customers are provided by billing server 128. In these examples, a customer account is associated only with a single user. Billing database 134 is used by billing server 128 to track and bill for services by servers 120, 122, and 124. The management and billing for services provided to customer premises 102 are provided through these backend services. These backend services may be implemented within one or more servers. Additionally, other backend services not shown may be provided.

In these examples, PC 106, PC 108, PC 110, and gateway 114 are located on customer premises 102 and do not normally move from place to place. The services and billing for these services are static because the locations do not change. These services may change in response to a change in subscription. Notebook 116, however, will change locations. The services provided to notebook 116 may change depending on the location of notebook 116 even though the subscription to services has not changed. Some services, such as on-site service, may be unavailable depending on the location of notebook 116. Other services may always be available, but the charges for these services may change depending on the location on notebook 116.

The present invention provides a business model of regional charging for the provision of subscription computing services. The present invention provides a mechanism for a user to have access to a full portfolio of subscription computing services regardless of the current location of the user with the service provider being compensated for the increased cost of providing distance-sensitive services.

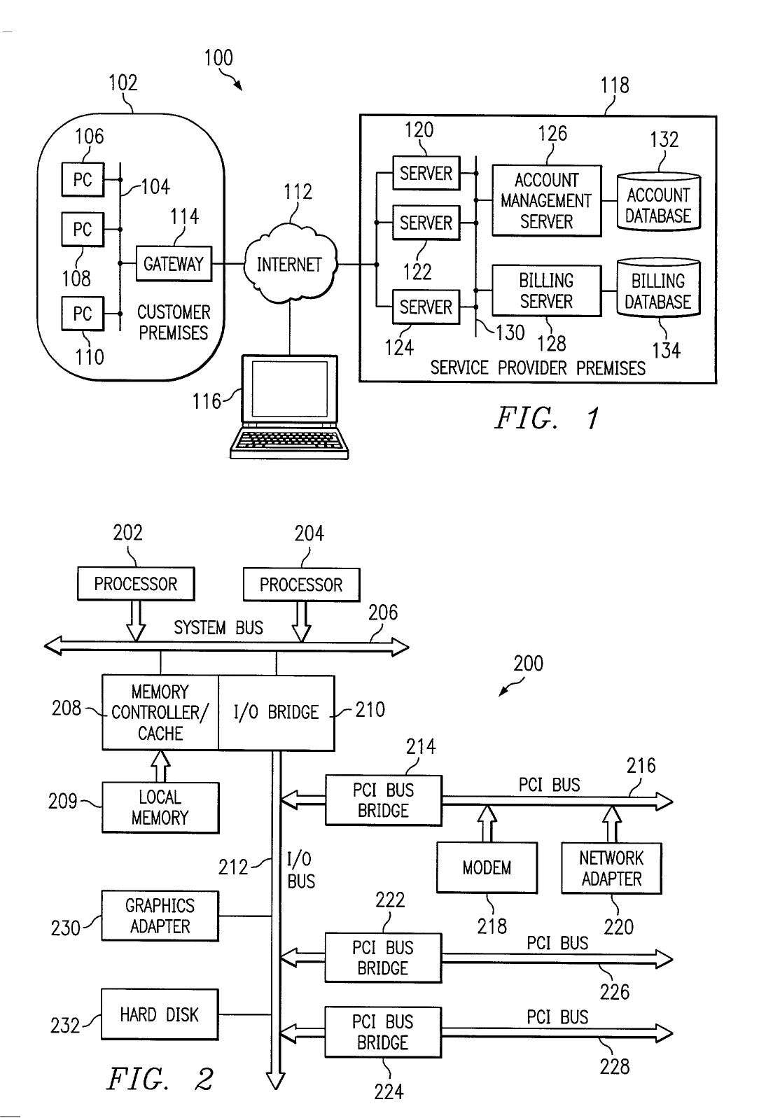

Referring to FIG. 2, a block diagram of a data processing system that may be implemented as a server, such as server 120, server 122, or server 124 in FIG. 1, is depicted in accordance with a preferred embodiment of the present invention. Additionally, backend services, such as account management 126 and billing 128, may be implemented in data processing system 200.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to personal computers 108-110 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

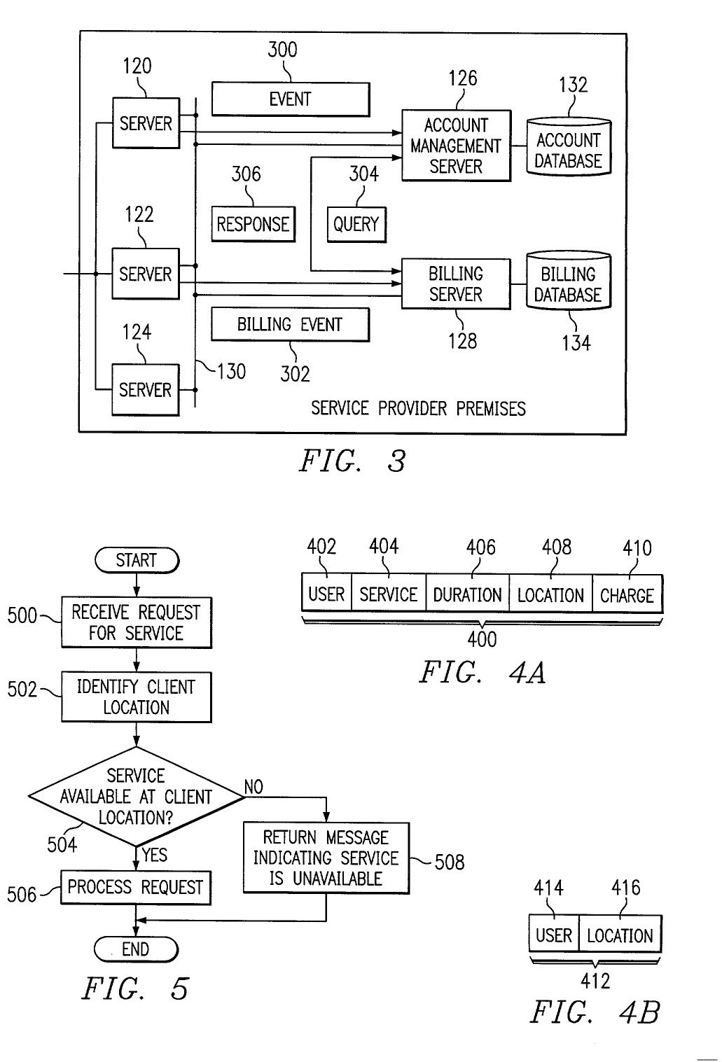

Turning next to FIG. 3, a diagram illustrating processing of billing events is depicted in accordance with a preferred embodiment of the present invention. Server 120, server 122, server 124, account management server 126, and billing server 128 communicate using local area network 130 by sending messages. In the depicted examples in FIG. 3, event message 300 is sent from server 120 to account management server 126. Billing event message 302 is sent from server 122 to billing server 128. Additionally, query message 304 and response message 306 are sent between account management server 126 and billing server 128.

In this example, event message 300 is intended to represent a message from server 120 containing location information for a mobile unit, such as notebook 116 in FIG. 1. This location information may be derived in several ways. For example, the location information may be supplied by the user of notebook 116. Alternatively, this information maybe accessed from location determination hardware in notebook 116. This hardware may be, for example, global positioning system (GPS) hardware. The location information also may be inferred from the area code of the telephone connection that is being used by notebook 116 via a caller identification feature. Account management server 126 stores the current location of the user of notebook 116 into account database 132.

Billing event message 302 is a message received from the service currently implemented on server 122 to billing server 128 to indicate that the service is being used by the user of notebook 116. Billing server 128 retains this information for subsequent billing. Upon receipt of billing event message 302 billing server 128 originates query message 304 to account management server 126, querying account database 114 for the customer record associated with the user of notebook 116. This record is retrieved from account database 132 by account management server 126 and returned in response 306 to billing server 128. Thus, billing server 128 can be made aware of the current user location at the time that billing event 302 is received from server 122.

Billing server 128 then uses this current location information, together with the billing event message 302, to make an entry into billing database 134. This entry records that fact that a specific service was in use by a specific customer from a specific location. Server 122 originates another billing event message at a later time indicating that use of the service has terminated, and billing server 128 makes a second entry into billing database 134 to record the duration of use of the service.

The mechanism described above permits billing server 128 to retain information about which services have been used from which locations. Logic within billing server 128 can analyze this information with respect to region definitions, also stored in billing database 134, that associate locations with regions. A further set of database entries in billing database 134 associate a specific charge with a specific service and a specific region, so that charging can be accomplished sensitive to both the service and the user location when the service is used.

With reference now to FIGS. 4A-4B, diagrams of database entries are depicted in accordance with a preferred embodiment of the present invention. In FIG. 4A, entry 400 is an example of an entry that may be found in billing database 134 in FIG. 1. In this example, entry 400 includes user 402, service 404, duration 406, location 408, and charge 410. User 402, service 404, duration 406, and location 408 are used to generate charge 410 using billing services provided by billing server 128 in FIG. 1. In FIG. 4B, entry 412 is an example of an entry that may be found in account database 132 in FIG. 1. Entry 412 includes user 414 and location 416 in these examples. This entry is used by account management server 126 in FIG. 1 to manage users and accounts.

Turning next to FIG. 5, a flowchart of a process used for processing a request for a service is depicted in accordance with a preferred embodiment of the present invention. The process illustrated in FIG. 5 may be implemented in an account management server, such as account management server 126 in FIG. 1. This process is used to determine whether a service can be provided to a user at a particular client location.

The process begins by receiving a request for service from a client (step 500). The request may be received from a client, such as notebook 116 in FIG. 1. Next, a client location is identified (step 502). The client location may be identified from the request itself or through other mechanisms, such as caller identification information received when a call is initiated to establish a communications link. A determination is made as to whether service is available at the client location (step 504). Some services may be unavailable depending on the particular client location. For example, if a mobile unit moves outside of certain regions, on-site service may be unavailable. If service is available at the client location, the request is processed (step 506) with the process terminating thereafter. In these examples, the request is processed through a server, such as server 120, server 122, or server 124 in FIG. 1. If service is not available at the client location, a message indicating that service is unavailable is returned to the client (step 508) and the process terminates.

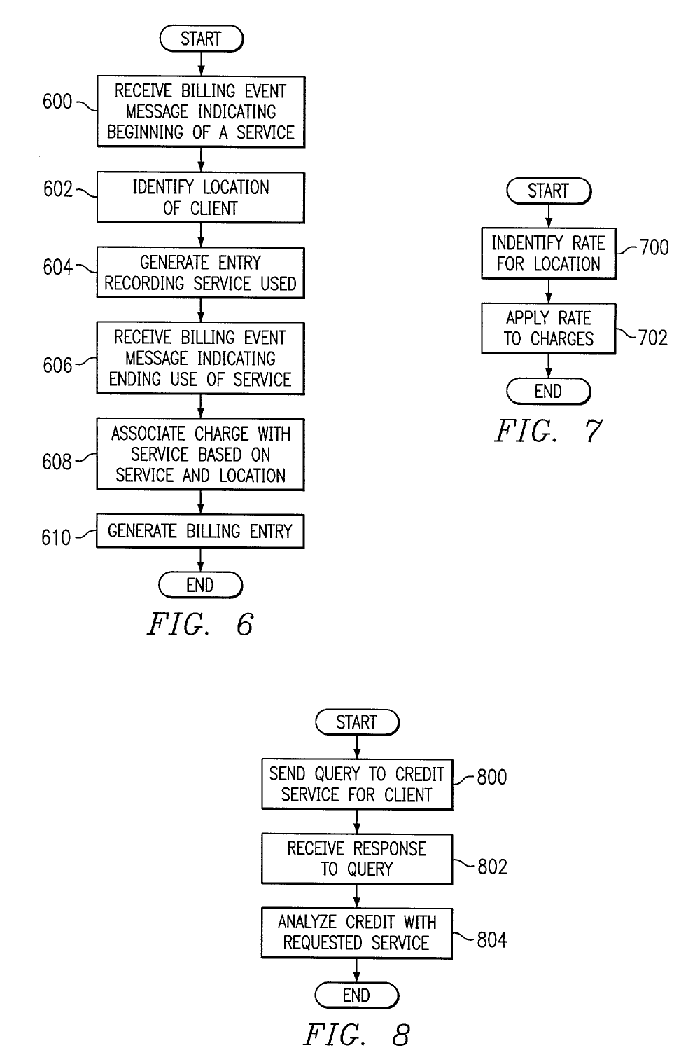

With reference now to FIG. 6, a flowchart of a process used for generating a billing entry for a service is depicted in accordance with a preferred embodiment of the present invention. The process illustrated in FIG. 6 may be implemented in a billing server, such as billing server 128 in FIG. 1.

The process begins by receiving a billing event message indicating the beginning of a service (step 600). Next, a client location is identified (step 602). An entry is then generated recording the used service (step 604). A billing event message is received in which the billing event indicates that the use of the service has ended (step 606). Then, a charge for the service is based on the service and location (step 608). A billing entry based on the charge is generated (step 610) and the process terminates.

Turning next to FIG. 7, a flowchart of a process used for generating a charge is depicted in accordance with a preferred embodiment of the present invention. The process illustrated in FIG. 7 may be implemented in a billing server, such as billing server 128 in FIG. 1.

The process begins by identifying a rate for a location (step 700). The rate may be a flat fee for a service or a fee based on a per unit of time use. Next, the rate is applied to the use of the service (step 702) with the process terminating thereafter. If the rate is a per unit of time use, the rate is multiplied by the amount of time used for the service. The result forms a charge, which may be placed into charge 410 in FIG. 4 for use in billing the customer.

With reference now to FIG. 8, a flowchart of a process used for determining whether to provide a service is depicted in accordance with a preferred embodiment of the present invention. The process illustrated in FIG. 8 may be implemented in a billing server, such as billing server 128 in FIG. 1. This process may be initiated in cases in which the charges are increased based on the location of a client. With the increased rates, a concern may be present as to whether the client is credit worthy and should be provided the service at this particular location.

The process begins by sending a query to a credit service for a client (step 800). The credit service, may be, for example, a credit company or some other financial institution. The query may include a potential or estimated charge for the service. Next, a response to the query is received (step 802). Then, credit with the requested service is analyzed (step 804) with the process terminating thereafter. This analysis is used to determine whether to provide the service to the client at this particular location.

Thus, the present invention provides an improved method, apparatus, and computer implemented instructions for subscription services in which a client may change locations. The mechanism of the present invention allows for differential billing based on the location of the client. In particular, the location of the client may affect the cost of providing services to the client. Different factors taken into account include available bandwidth, latency of data transfer, and whether services, such as on-site services, can be provided at the client location. In this manner, mobile clients may be provided with services outside of the customer premises with the service provided being able to differentially charge for these services. For example, an on-site service may be provided at one rate on the customer premises, but at another rate off the customer premises. The service provider may contract with other on-site service providers or have reciprocal agreements to expand the geographic area in which this type of service may be provided.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the network data processing system in FIG. 1 illustrates the Internet and a LAN, the mechanism of the present invention may include types of networks in addition to or in place of these, such as an intranet or a wide area network (WAN). The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing subscription computing services, the method comprising:
providing subscription computing services to a set of clients in a network data processing system; and
billing a mobile client with in the set of clients for a subscription computing service based on a location of the mobile client.

2. The method of claim 1, wherein a rate used to bill the mobile client for the subscription computing service is based on a cost of providing the subscription computing service to the mobile client at the location.

3. The method of claim 1, wherein the subscription computing service includes at least one of online user help, on site-support, backup of data, anti-virus support, and software installation.

4. The method of claim 1, wherein the network data processing system includes at least one of an Internet, an intranet, a wide area network, or a local area network.

5. A method in a data processing system for managing services, the method comprising:
receiving a request for a service from a client;
identifying a location of the client in response to receiving the request; and
billing the client for the service based on the location of the client.

6. The method of claim 5, wherein the location is a customer premises.

7. The method of claim 6 wherein the location is a location off the customer premises.

8. The method of claim 5 further comprising:
selectively providing the service based on the location of the client.

9. The method of claim 8, wherein the service is unavailable if the client is within a selected location.

10. The method of claim 8, wherein the service is unavailable if the client is outside of a selected location.

11. The method of claim 5, wherein the service is one of a remote automatic diagnosis service, technical support, a self help service, or on-site support.

12. The method of claim 5, wherein the identifying step comprises:
identifying the location of the client using a global positioning system.

13. The method of claim 5, wherein the identifying step comprises:
identifying the location of the client using caller identification information received when the client establishes a communications link to the data processing system.

14. The method of claim 5, wherein the location is identified in the request.

15. The method of claim 5, wherein the client is billed based on a bandwidth available from the location.

16. The method of claim 5, wherein the client is billed based on a distance between the location and the data processing system.

17. The method of claim 5, wherein billing of the client is based on latency of data transfer between the client and the data processing system at the location.

18. The method of claim 5, wherein the billing of the client is based on available bandwidth for data transfer between the client and the data processing system at the location.

19. The method of claim 5, wherein the client is a mobile client.

20. The method of claim 5, wherein the services are subscription computing services.

21. A method in a data processing system for managing services, the method comprising:
receiving a request for a service from a client;
identifying a current location of the client in response to receiving the request; determining whether to provide the service based on the current location of the client; providing the service in response to a determination to provide the service; and
billing the client for the service based on the current location of the client if the service is provided to the client.

22. The method of claim 21, wherein the client is a mobile client.

23. A network data processing system comprising:
a network;
a plurality of clients, wherein the plurality of clients establish communications links to the network; and
a server in communication with the network, wherein the server provides services to the plurality of clients and wherein the server receives a request for a service from a client; identifies a location of the client in response to receiving the request; and bills the client for the service based on the location of the client.

24. The network data processing system of claim 23, wherein one client with the plurality of clients is a mobile client and requests services from more than a single location at different times.

25. A data processing system comprising:
a bus system;
a communications unit connected to the bus system;
a memory connected to the bus system, wherein the memory includes a set of instructions; and
a processing unit connected to the bus system, wherein the processing unit executes the set of instructions to provide subscription computing services to a set of clients in a network data processing system; and bill a mobile client with in the set of clients for a subscription computing service based on a location of the mobile client.

26. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request for a service from a client; identify a location of the client in response to receiving the request; and bill the client for the service based on the location of the client.

27. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request for a service from a client; identify a current location of the client in response to receiving the request; determine whether to provide the service based on the current location of the client; provide the service in response to a determination to provide the service; and bill the client for the service based on the current location of the client if the service is provided to the client.

28. A data processing system for managing subscription computing services, the data processing system comprising:
providing means for providing subscription computing services to a set of clients in a network data processing system; and
billing means for billing a mobile client with in the set of clients for a subscription computing service based on a location of the mobile client.

29. The data processing system of claim 28, wherein a rate used to bill the mobile client for the subscription computing service is based on a cost of providing the subscription computing service to the mobile client at the location.

30. The data processing system of claim 28, wherein the subscription computing service includes at least one of online user help, on site-support, backup of data, anti-virus support, and software installation.

31. The data processing system of claim 28, wherein the network data processing system includes at least one of an Internet, an intranet, a wide area network, or a local area network.

32. A data processing system for managing services, the data processing system comprising:
receiving means for receiving a request for a service from a client;
identifying means for identifying a location of the client in response to receiving the request; and
billing means for billing the client for the service based on the location of the client.

33. The data processing system of claim 32, wherein the location is a customer premises.

34. The data processing system of claim 33 wherein the location is a location off the customer premises.

35. The data processing system of claim 32 further comprising:
providing means for selectively providing the service based on the location of the client.

36. The data processing system of claim 35, wherein the service is unavailable if the client is within a selected location.

37. The data processing system of claim 35, wherein the service is unavailable if the client is outside of a selected location.

38. The data processing system of claim 32, wherein the service is one of a remote automatic diagnosis service, technical support, a self help service, or an on-site support.

39. The data processing system of claim 32, wherein the identifying means comprises:
means for identifying the location of the client using a global positioning system.

40. The data processing system of claim 32, wherein the identifying means comprises:
means for identifying the location of the client using caller identification information received when the client establishes a communications link to the data processing system.

41. The data processing system of claim 32, wherein the location is identified in the request.

42. The data processing system of claim 32, wherein the client is billed based on a bandwidth available from the location.

43. The data processing system of claim 32, wherein the client is billed based on a distance between the location and the data processing system.

44. The data processing system of claim 32, wherein billing of the client is based on latency of data transfer between the client and the data processing system at the location.

45. The data processing system of claim 32, wherein the billing of the client is based on available bandwidth for data transfer between the client and the data processing system at the location.

46. The data processing system of claim 32, wherein the client is a mobile client.

47. A data processing system for managing services, the data processing system comprising:
receiving means for receiving a request for a service from a client;
identifying means for identifying a current location of the client in response to receiving the request;
determining means for determining whether to provide the service based on the current location of the client;
providing means for providing the service in response to a determination to provide the service; and
billing means for billing the client for the service based on the current location of the client if the service is provided to the client.

48. The data processing system of claim 47, wherein the client is a mobile client.

49. A computer program product in a computer readable medium for managing subscription computing services, the computer program product comprising:
first instructions for providing subscription computing services to a set of clients in a network data processing system; and
second instructions for billing a mobile client with in the set of clients for a subscription computing service based on a location of the mobile client.

50. The computer program product of claim 49, wherein a rate used to bill the mobile client for the subscription computing service is based on a cost of providing the subscription computing service to the mobile client at the location.

51. The computer program product of claim 49, wherein the subscription computing service includes at least one of online user help, on site-support, backup of data, anti-virus support, and software installation.

52. The computer program product of claim 49, wherein the network data processing system includes at least one of an Internet, an intranet, a wide area network, or a local area network.

53. A computer program product in a computer readable medium for managing services, the computer program product comprising:
first instructions for receiving a request for a service from a client;
second instructions for identifying a location of the client in response to receiving the request; and
third instructions for billing the client for the service based on the location of the client.

54. The computer program product of claim 53, wherein the location is a customer premises.

55. The computer program product of claim 54 wherein the location is a location off the customer premises.

56. The computer program product of claim 53 further comprising:
fourth instructions for selectively providing the service based on the location of the client.

57. The computer program product of claim 56, wherein the service is unavailable if the client is within a selected location.

58. The computer program product of claim 56, wherein the service is unavailable if the client is outside of a selected location.

59. The computer program product of claim 53, wherein the service is one of a remote automatic diagnosis service, technical support, a self help service, or an on-site support.

60. The computer program product of claim 53, wherein the second instructions comprises:
sub-instructions for identifying the location of the client using a global positioning system.

61. The computer program product of claim 53, wherein the second instructions comprises:
sub-instructions for identifying the location of the client using caller identification information received when the client establishes a communications link to the data processing system.

62. The computer program product of claim 53, wherein the location is identified in the request.

63. The computer program product of claim 53, wherein the client is billed based on a bandwidth available from the location.

64. The computer program product of claim 53, wherein the client is billed based on a distance between the location and the data processing system.

65. The computer program product of claim 53, wherein billing of the client is based on latency of data transfer between the client and the data processing system at the location.

66. The computer program product of claim 53, wherein the billing of the client is based on available bandwidth for data transfer between the client and the data processing system at the location.

67. The computer program product of claim 53, wherein the client is a mobile client.

68. A computer program product in a computer readable medium for managing services, the computer program product comprising:
first instructions for receiving a request for a service from a client;
second instructions for identifying a current location of the client in response to receiving the request;
third instructions for determining whether to provide the service based on the current location of the client;
fourth instructions for providing the service in response to a determination to provide the service; and
fifth instructions for billing the client for the service based on the current location of the client if the service is provided to the client.

69. The computer program product of claim 68, wherein the client is a mobile client.
